(19) United States
(12) Patent Application Publication
(10) Pub. No.: US 2006/0137139 A1
(43) Pub. Date: Jun. 29, 2006

(54) Hinge device able to adjust a distance between a door and a doorframe in different manners

(76) Inventor: Zhi-Yong Wu, Fo-Shan City (CN)

Correspondence Address: NIKOLAI & MERSEREAU, P.A., 900 SECOND AVENUE SOUTH, SUITE 820, MINNEAPOLIS, MN, 55402, US

(21) Appl. No.: 11/281,335

(22) Filed: Nov. 17, 2005

(30) Foreign Application Priority Data
Nov. 19, 2004 (CN) 200420095620.X

(51) Int. Cl. E05D 7/04

(52) U.S. Cl. 16/236

(57) ABSTRACT

A hinge device has a base adapted for secured engagement with the doorframe, a mediate plate movably connected to the base via a first adjustable cam in a first direction and a top plate movably connected to the mediate plate via a second adjustable cam in a second direction which is orthogonal to the first direction An adjustable bolt is adapted to be threadingly extended through a portion of the arm to connect to a portion of the top plate and to abut a surface of the mediate plate. Therefore, rotation of the first adjustable cam drives the base to move relative to the mediate plate in the first direction, rotation of the second adjustable cam drives the mediate plate as well as the base to move relative to the top plate in the second direction and rotation of the adjustable bolt changes a distance between the moving seat and the adjustable seat.

### BACKGROUND OF THE INVENTION

1. Field of the Invention

The present invention relates to a hinge device, and more particularly to a hinge device having a moving seat adapted to be mounted on a door and a adjustable seat adapted to be mounted on a doorframe and an arm mounted between the moving seat and the adjusting seat. The adjustable seat has a base, a mediate plate slidably mounted on the base and a top plate movably mounted on the mediate plate such that misalignment between the door and the doorframe is re-aligned via the movement of the mediate plate and/or the top plate. Further, a distance between the door and the doorframe is adjusted by movement of the arm.

2. Description of the Prior Art

A hinge device is mounted between the door and the doorframe to allow the door to pivot relative to the doorframe. A Chinese patent 03237822x discloses a hinge device including a moving seat adapted to be mounted on a door, a fixed seat adapted to be mounted on a doorframe and an arm pivotally connected to both the moving seat and the fixed seat. The fixed seat is composed of an adjustable plate and a fixed plate. The adjustable plate has a T-shaped recess defined in a bottom thereof to correspond to and receive therein a step formed on two opposite sides of the fixed plate so that the adjustable plate is movable relative to the fixed plate. However, the movement of the adjustable plate relative to the fixed plate is only two dimensional, which can not mitigate a distance between the door and the doorframe.

To overcome the shortcomings, the present invention tends to provide an improved hinge device to mitigate the aforementioned problems.

### SUMMARY OF THE INVENTION

The primary objective of the present invention is to provide a hinge device having a moving seat and a adjustable seat and an arm pivotally mounted between the moving seat and the adjusting seat. The adjustable seat has a base, a mediate plate slidably mounted on the base and a top plate movably mounted on the mediate plate such that misalignment between the door and the doorframe is re-aligned via the movement of the mediate plate and/or the top plate.

Another objective of the present invention is that a distance between the door and the doorframe is adjusted by movement of the arm.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the hinge device in accordance with the present invention;

FIG. 2 is a perspective view of the adjustable seat;

FIG. 3 is a cross sectional view taken from line A-A of FIG. 1;

FIG. 4 is an exploded perspective view of the hinge device of the present invention;

FIGS. 5A and 5B are perspective views of the base;

FIGS. 6A and 6B are perspective views of the mediate plate;

FIGS. 7A and 7B are perspective views of the top plate;

FIG. 8 is a perspective view of the adjustable cam of the present invention;

FIG. 9 is a perspective view of the adjustable bolt of the present invention;

FIG. 10 is an operational view showing the application of the hinge device of the present invention on the door and the doorframe;

FIG. 11 is an operational view showing that the dustproof cap is pivoted;

FIG. 12 is an operational view of the hinge device of the present invention;

FIG. 13 is a schematic cross sectional view showing how the dustproof cap is pivoted relative to the adjustable seat via a pin;

FIG. 14 is a perspective view of the hinge device of the present invention;

FIG. 15 is a perspective view of the adjustable seat of the present invention;

FIG. 16 is a cross sectional view taken from line D-D in FIG. 14;

FIGS. 17A and 17B are perspective views of the base;

FIGS. 18A and 18B are perspective views of the mediate plate; and

FIGS. 19A and 19B are perspective views of the top plate.

### DETAILED DESCRIPTION OF THE PREFERRED EMBODIMENT

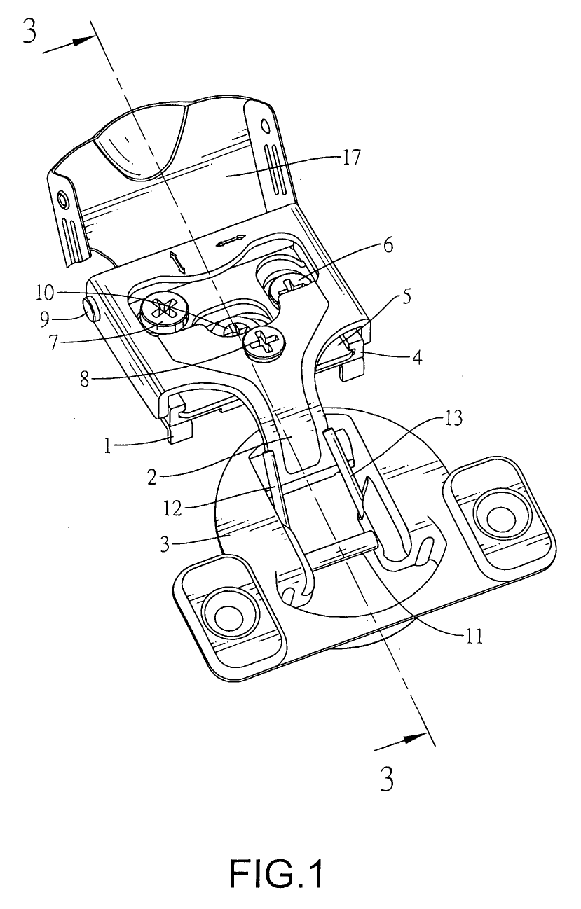

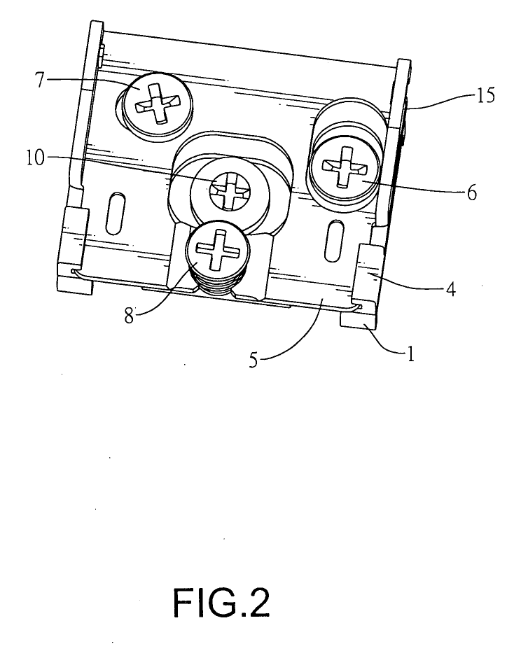

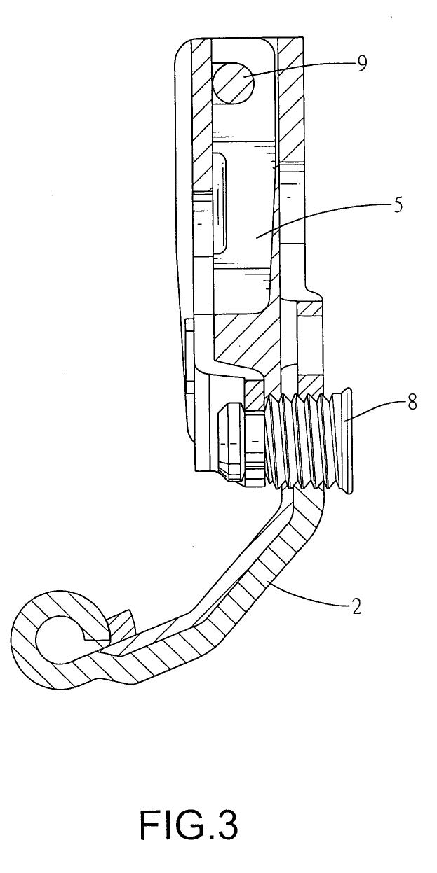

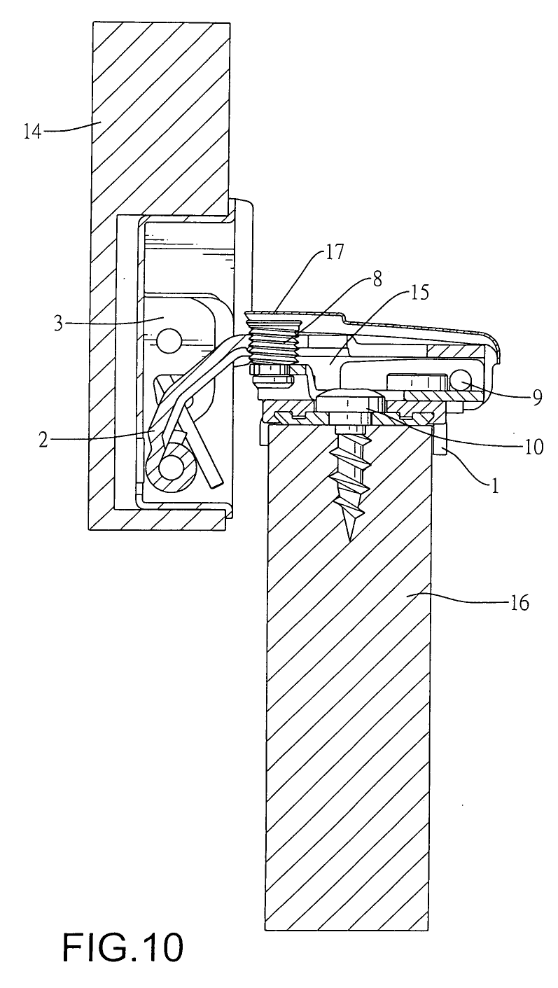

With reference to FIGS. 1-4 and FIG. 10, the hinge device in accordance with the present invention includes a moving seat (3) adapted to be mounted on a door (14), an adjustable seat (15) adapted to be mounted on a doorframe (16) and an arm (2) pivotally mounted to the moving seat (3) and firmly connected to the adjustable seat (15). The arm (2) has two flanges (2.1) formed on two opposite sides of the arm (2). The adjustable seat (15) is composed of a base (1), a mediate plate (4) movably mounted on top of the base (1) and a top plate (5) movably mounted on top of the mediate plate (4). The moving seat (3) has a U-shaped pin (11) and two springs (12,13) mounted therein to provide a force for pivoting the door (14) away from the doorframe (16). How the pin (11) and the two springs (12,13) move the door (14) away from the doorframe (14) is conventional in the art such that detailed description thereof is omitted hereinafter. The adjustable seat (15) has a first adjustable cam (6), a second adjustable cam (7) both rotatably mounted therein and an adjustable bolt (8) threadingly extended through the arm (2) to securely connect to the top plate (5) of the adjustable seat (15). A securing bolt (10) is mounted through the moving seat (3) to secure the moving seat (3) on the door (14).

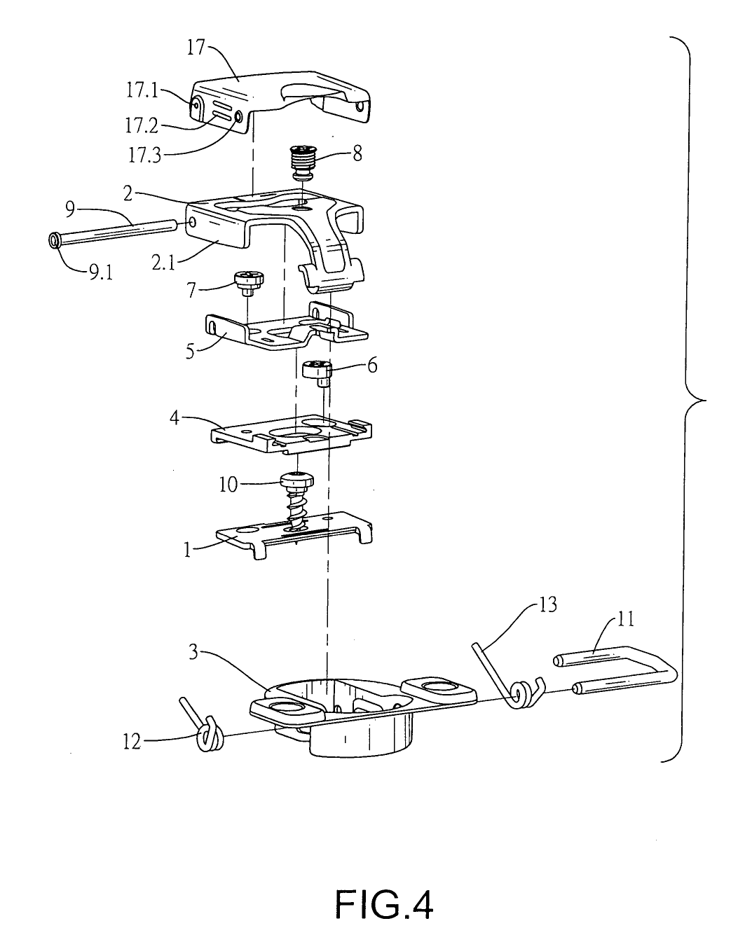

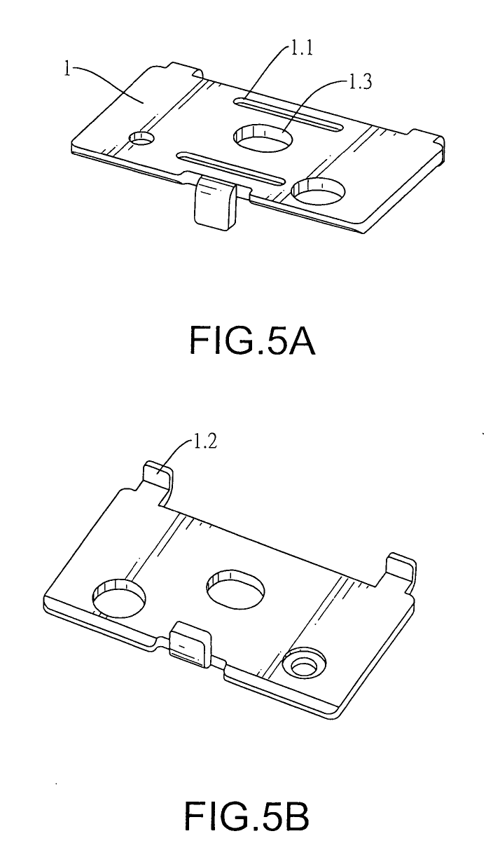

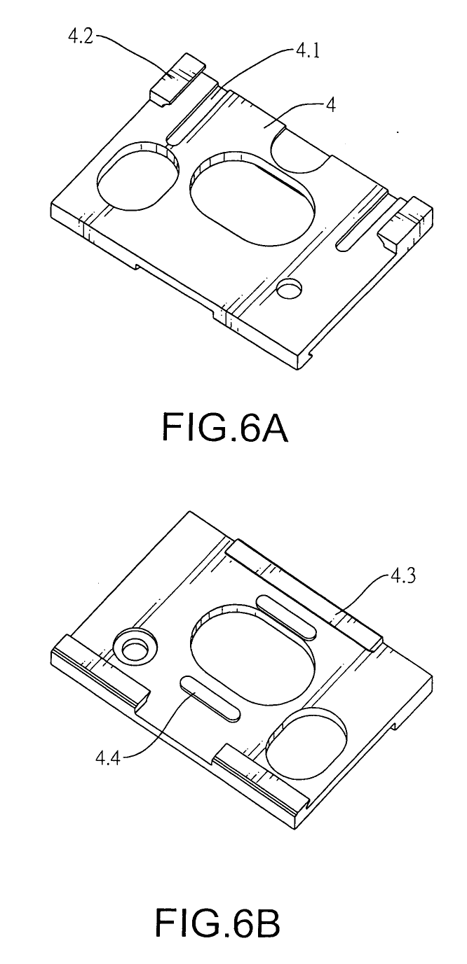

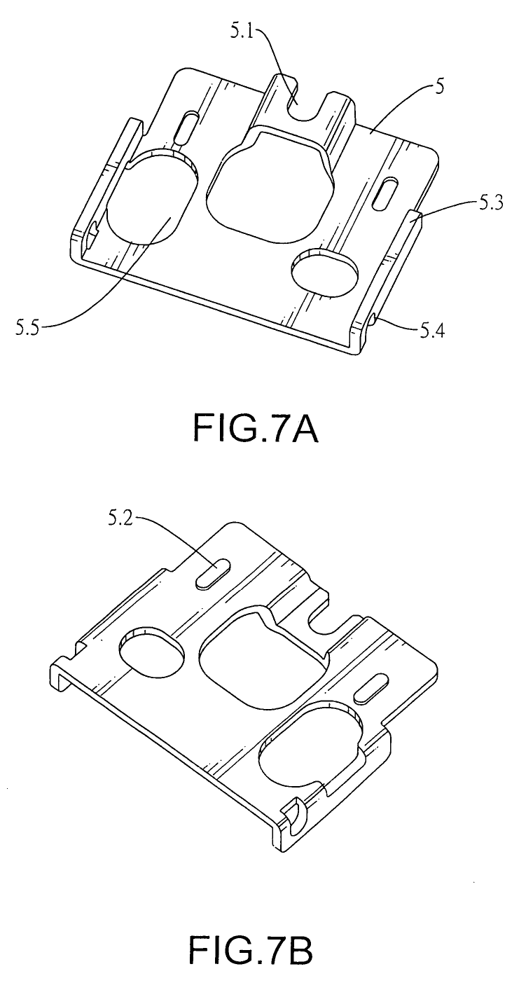

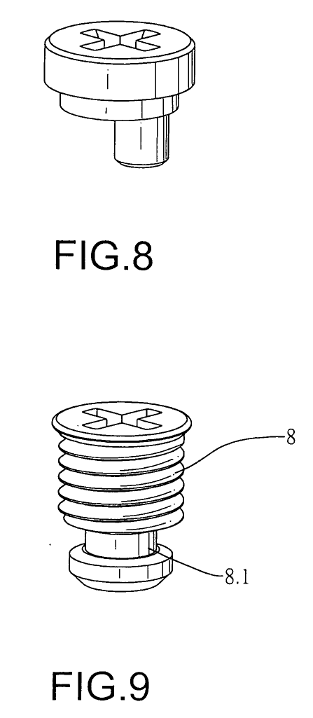

With reference to FIGS. 5A to 7B, the base (1) is rectangular and has legs (1.2) formed on two opposite sides of the base (1) so that the base (1) is able to securely connect to the doorframe (16), two slits (1.1) defined therein and a through hole (1.3) defined to correspond to the securing bolt (10) as shown in FIG. 4. The mediate plate (4) has first flanges (4.3) extending from two opposite sides of a bottom face thereof to receive therein the base (1), two ribs (4.4) formed on a side face thereof to be movably received in the two slits (1.1) of the base (1) and two elongated recesses (4.1). The mediate plate (4) further has two second flanges (4.2) oppositely formed relative to the first flanges (4.3) to correspond to the top plate (5) and a first elliptical hole (4.5). The top plate (5) has second flanges (5.3) formed on two opposite sides of the top plate (5), a pin hole (5.4) defined at a joint between a corresponding second flange (5.3) and a base body of the top plate (5) to allow a pin (9) to extend therethrough so as to connect to one end of the arm (2), two guiding rids (5.2) formed to be movably received in the two elongated recesses (4.1) of the mediate plate (4) and a mouth extending from a center of the top plate (5) and having a cutout (5.1). The top plate (5) further has a second elliptical hole (5.5) defined therethrough. With reference to FIGS. 8 and 9, the adjustable cam (6,7) has an eccentric rod extending from a bottom of a head. The adjustable bolt (8) is received in a threaded hole (not numbered) in the arm (2) and has a neck (8.1) and an outer threading formed on an outer periphery thereof. The neck (8.1) of the adjustable bolt (8) is received in the cutout (5.1) of the top plate (5).

The arm (2) has a first end pivotally connected to the moving seat (3) via the U-shaped pin (11) and the two springs (12,13) and a second end firmly connected to the adjustable seat (15). The method applied to pivotally connect the first end of the arm (2) to the moving seat (3) is conventional in the art, thus detailed description thereof is omitted.

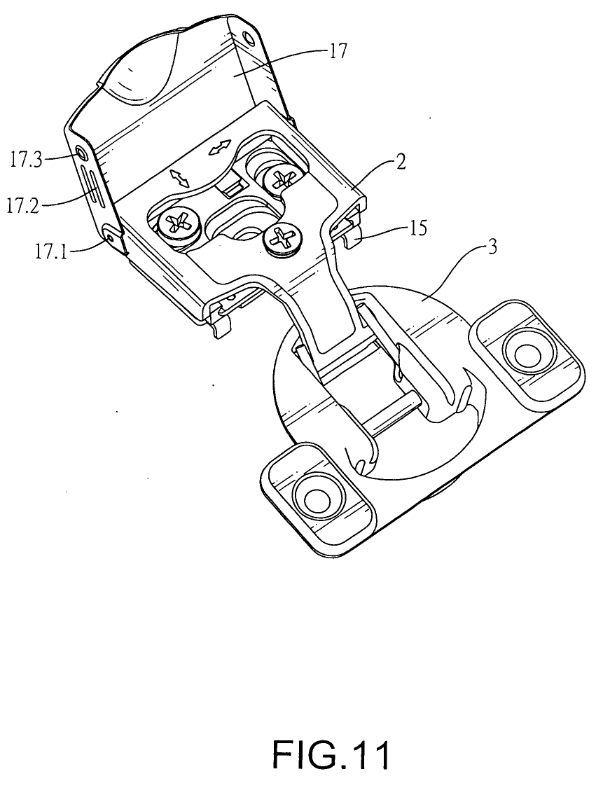

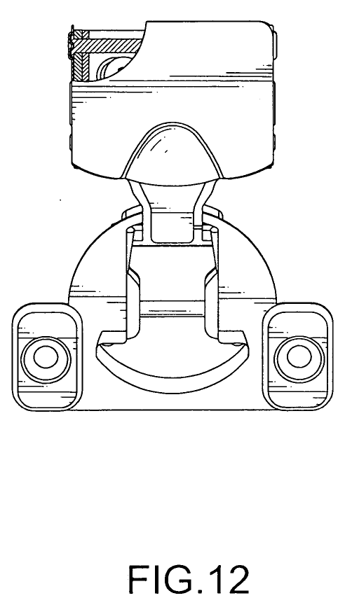

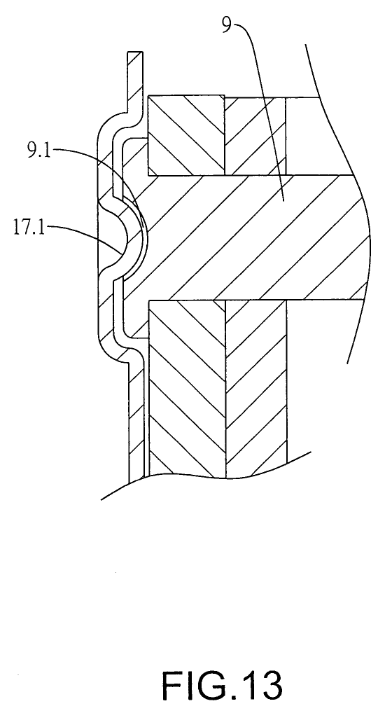

With reference to FIGS. 11 to 13, the dustproof cap (17) is pivotally connected to pivotal recesses (9.1) of the pin (9) which is extended through the adjustable seat (15) and has a connection boss (17.1) formed on two opposite inner face of downwardly extended walls thereof so that the connection bosses (17.1) are able to be received in the pivotal recesses (9.1) to allow the dustproof cap (1 7) to pivot relative to the adjustable seat (5) after the pin (9) is extended through the adjustable seat (5). Furthermore, the dustproof cap (17) has, in addition to the connection bosses (17.1), two bosses (17.3) and patterns (17.2) formed on the inner face of the extended walls of the dustproof cap (17). With the formation of the bosses (17.3), the dustproof cap (17) is able to connect to the top plate (5).

After assembly of the hinge device of the present invention, it is noted from FIG. 1 that the adjustable cam (6) is extended through the first elliptical hole (4.5) to firmly connect to a surface of the base (1) and the adjustable cam (7) is extended through the second elliptical hole (5.5) of the top plate (5) to firmly connect to a face of the mediate plate (4). Therefore, rotation of the adjustable cam (6) will lead to a consequence that the eccentric rod of the adjustable cam (6) drives the base (1) to move sideways relative to the mediate plate (4) as well as the top plate (5). Also, rotation of the adjustable cam (7) will lead to a consequence that the eccentric rod of the adjustable cam (7) drives the base (1) as well as the mediate plate (4) to move up-and-down relative to the top plate (5). Furthermore, because the neck (8.1) of the adjustable bolt (8) is received in the cutout (5.1) of the mouth of the top plate (5), rotation of the adjustable bolt (8) changes a distance between the moving seat (3) and the adjustable seat (15).

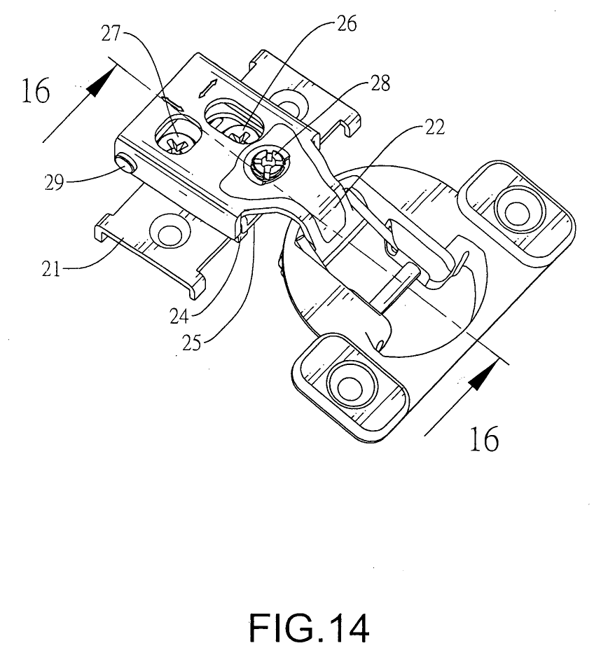

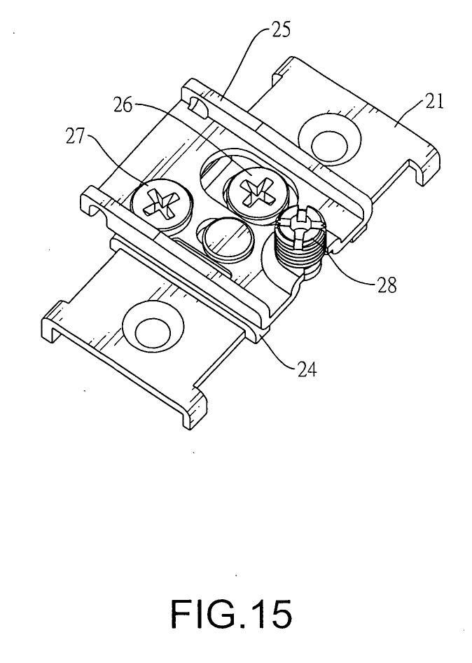

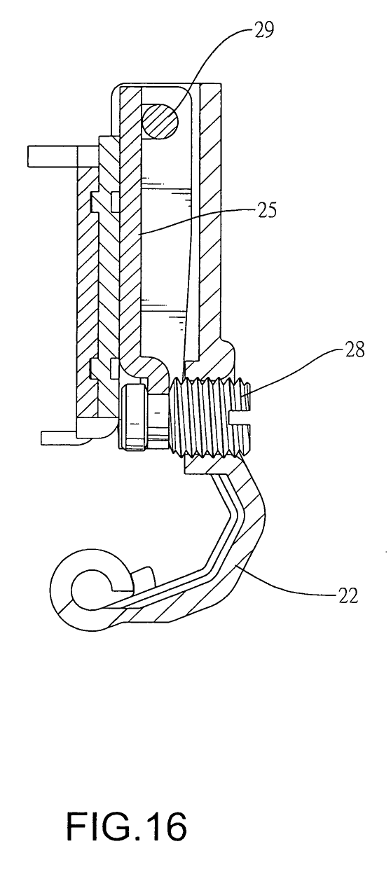

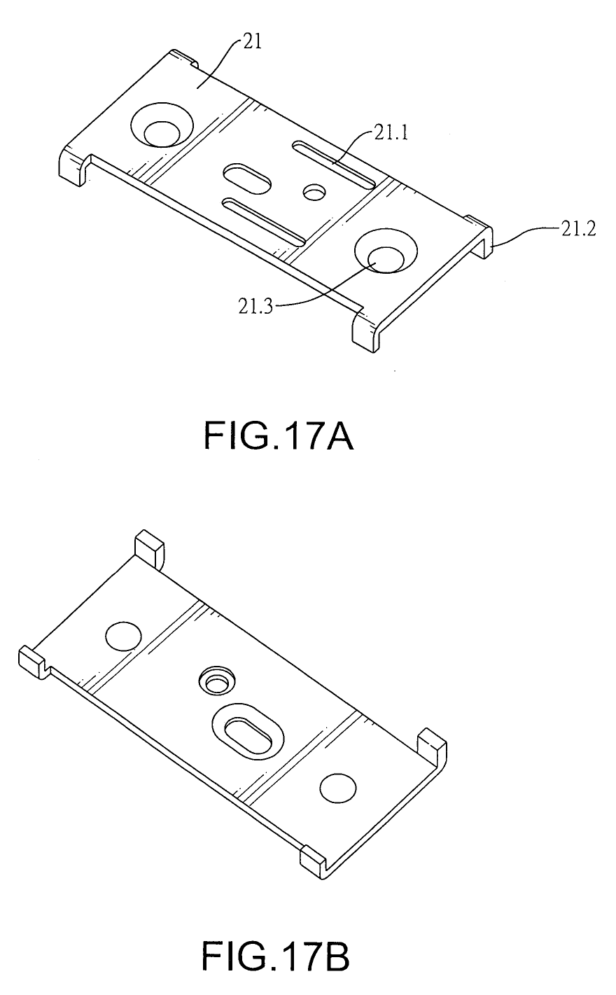

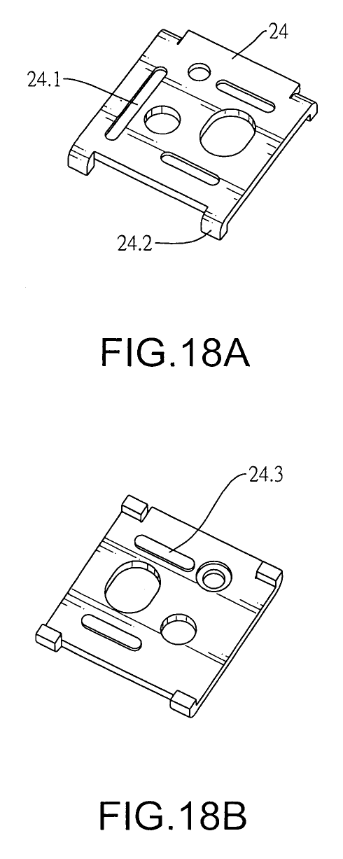

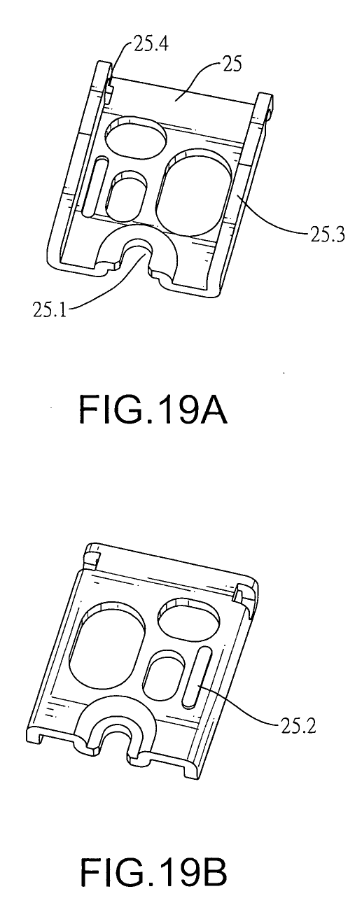

With reference to FIGS. 14 to 19, another embodiment of the hinge device of the present invention is shown. The base (21) of the hinge device is rectangular and has a positioning legs (21.2) formed on four corners thereof, two first holes (21.3) defined in two opposite sides of the base (21) and two slits (21.1). The mediate plate (24) has four legs (24.2) respectively formed on four corners of the mediate plate (24) to connect to the base (21), two ribs (24.3) formed to correspond to and be received in the two slits (21.1) of the base (21). A first adjustable cam (26) is able to extend through the mediate plate (24) to firmly connect to the base (21) such that the rotation of the first adjustable cam (26) enables the base (21) to move sideways relative to the mediate plate (24). The mediate plate (24) further has an elongated slit (24.1), as shown in FIG. 18. The top plate (25) has a guiding rob (25.2) corresponding to the elongated slit (24.1), two flanges (25.3) respectively formed on two opposite sides of the top plate (25) and a pin hole (25.4) defined at a joint of the flanges (25.3) of the surface of the top plate (25) to allow extension of a pin (29) so as to connect to an arm (22). The top plate (25) further has a mouth and a cutout (25.1). The difference between this embodiment and the previous embodiment is that the positioning structure among the base (1,21), the mediate plate (4, 24) and the top plate (5,25) and the rest of the operational movement of the hinge device is the same as that described earlier. Therefore, rotation of the first adjustable cam (26) allows the base (21) to move sideways relative to the mediate plate (24) as well as the top plate (25). Also, rotation of the adjustable cam (27) will lead to a consequence that the eccentric rod of the adjustable cam (27) drives the base (21) as well as the mediate plate (24) to move up-and-down relative to the top plate (25). Furthermore, because the neck of the adjustable bolt (28) is received in the cutout (25.1) of the mouth of the top plate (25), rotation of the adjustable bolt (28) changes a distance between the moving seat (3) and the adjustable seat (15).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge device comprising a moving seat adapted to be mounted on a door, an adjustable seat adapted to be mounted on a doorframe and an arm having a first end pivotally connected to the moving seat and a second end firmly connected to the adjustable seat, wherein the improvements comprise:
the adjustable seat is composed of a base adapted for secured engagement with the doorframe, a mediate plate movably connected to the base via a first adjustable cam in a first direction and a top plate movably connected to the mediate plate via a second adjustable cam in a second direction which is orthogonal to the first direction, and
an adjustable bolt is adapted to be threadingly extended through a portion of the arm to connect to a portion of the top plate and to abut a surface of the mediate plate such that rotation of the first adjustable cam drives the base to move relative to the mediate plate in the first direction, rotation of the second adjustable cam drives the mediate plate as well as the base to move relative to the top plate in the second direction and rotation of the adjustable bolt changes a distance between the moving seat and the adjustable seat.

2. The hinge device as claimed in claim 1, wherein the base has two slits respectively defined in two opposite sides of the base to correspond to two guiding ribs formed on the mediate plate such that the two guiding ribs are movably received in the two slits.

3. The hinge device as claimed in claim 2, wherein the base is rectangular and has legs formed on two opposite sides of the base so that the base is able to securely connect to the doorframe, and a through hole defined to correspond to the securing bolt,
the mediate plate has first flanges extending from two opposite sides of a bottom face thereof to receive therein the base, two elongated recesses and a first elliptical hole,
the top plate has second flanges formed on two opposite sides of the top plate, a pin hole defined to allow a pin to extend therethrough so as to connect to one end of the arm, and a mouth extending from a center of the top plate and having a cutout to receive therein a neck of the adjustable bolt such that the rotation of the adjustable bolt changes the distance between the moving seat and the adjustable seat.

4. The hinge device as claimed in claim 2, wherein the base is rectangular and has legs formed on four opposite sides of the base so that the base is able to securely connect to the doorframe, and a through hole defined to correspond to the securing bolt,
the mediate plate has first flanges extending from four opposite sides of a bottom face thereof to receive therein the base, two elongated recesses and a first elliptical hole,
the top plate has second flanges formed on four opposite sides of the top plate, a pin hole defined to allow a pin to extend therethrough so as to connect to one end of the arm, and a mouth extending from a center of the top plate and having a cutout to receive therein a neck of the adjustable bolt such that the rotation of the adjustable bolt changes the distance between the moving seat and the adjustable seat.

5. The hinge device as claimed in claim 3, wherein the arm has two flanges formed on two opposite sides thereof to securely connect to the top plate.

6. The hinge device as claimed in claim 4, wherein the arm as two flanges formed on two opposite sides thereof to securely connect to the top plate.

7. The hinge device as claimed in claim 6, wherein first adjustable cam and the second adjustable cam respectively have an eccentric rod extending from a head.

8. The hinge device as claimed in claim 6 further comprising a dustproof cam pivotally connected to the top plate.

9. The hinge device as claimed in claim 8, wherein the dustproof cap has two connection bosses respectively formed on an inner face of two downwardly extended walls thereof to correspond to two pivotal recesses respectively defined in two opposite ends of the pin and two bosses formed to connect to the top plate.
